(19) United States
(12) Patent Application Publication
(10) Pub. No.: US 2025/0322544 A1
(43) Pub. Date: Oct. 16, 2025

(54) DEVICE AND METHOD FOR CAPTURING DIFFERENT SCENE REGIONS AND CREATING A MAP OF THREE-DIMENSIONAL INFORMATION

(71) Applicant: Talent Unlimited Online Services Private Limited, Delhi (IN)

(72) Inventors: Rahul Prasad, Gurugram (IN); Ankit Prasad, Ranchi (IN); Mudit Rastogi, Raebareli (IN); Vedant Dere, Pune (IN)

(21) Appl. No.: 18/744,735

(22) Filed: Jun. 17, 2024

(30) Foreign Application Priority Data
Apr. 11, 2024 (IN) 202411029529

(51) Int. Cl. G06T 7/00; H04N 23/80

(52) U.S. Cl. CPC G06T 7/97; G06T 2207/20084; G06T 2207/20132; G06T 2207/20212

(57) ABSTRACT

Disclosed is a user device (102). The user device (102) includes a plurality of imaging sensors (118). The plurality of imaging sensors (118) is configured to capture a plurality of images of a scene and a processing unit (110) configured to implement a Deep Neural Network (DNN) model. The DNN model is configured to encode and aggregate, by way of a plurality of encoders and blocks where input and output is added, respectively, of the DNN model, information associated with the plurality of images in latent space and generate, by way of a decoder of the DNN model, a map of three-dimensional information based on the encoded information corresponding to each image of the plurality of images such that the map illustrates distances between one or more objects in the scene and the plurality of imaging sensors (118).

### TECHNICAL FIELD

The present disclosure relates to mobile photography, and more particularly to a device and a method for capturing different scene regions and creating a map of three-dimensional information for various applications, including parallax and bokeh effects.

### BACKGROUND

In an era where smartphones have become an extension of ourselves, it's no surprise that innovation knows no bounds. When an image capture component of a smartphone takes a picture of a scene, an image sensor collects data about the light coming through a photographic lens. To selectively blur an image to varying degrees, maps of three-dimensional (3D) information are utilized that are 3D representation of a scene that shows the distance of objects from a reference point, like a camera lens. Each pixel in the map is assigned a value that indicates the distance from the camera to that point in the scene. Generally, neural networks comprising an encoder and a decoder sub-networks connected in series are used to output such dense maps of a scene, based on a (single) image acquired by a camera. More recently, neural networks comprising an encoder sub-network, an LSTM network and a decoder sub-network, connected in series have been proposed. Consequently, compared with systems in which the map is based only on a single image, these networks exhibit improved accuracy, since their output is based on a series of successive images. However, the accuracy and the reliability of the depth values outputted by such networks remain limited. Thus, to address the aforementioned problems, there remains a need for a technical solution to provide a system and a method to generate high accuracy maps of three-dimensional information.

### SUMMARY

In an aspect of the present disclosure, a user device to generate a map of three-dimensional information is disclosed. The user device includes a plurality of imaging sensors. The plurality of imaging sensors is configured to capture a plurality of images of a scene. The user device further includes a processing unit configured to implement a Deep Neural Network (DNN) model, wherein the DNN model is configured to encode and aggregate, by way of a plurality of encoders and blocks where input and output is added, respectively, information associated with the plurality of images in latent space. Further, the DNN model is configured to generate, by way of a decoder, a map of three-dimensional information based on the encoded information corresponding to each image of the plurality of images such that the map of three-dimensional information illustrates distances between one or more objects in the scene and the plurality of imaging sensors.

In some aspects of the present disclosure, a first imaging sensor of the plurality of imaging sensors is configured to capture a first region of a scene such that the first designated region contributes to the map and an image composition, (ii) a second imaging sensor of the plurality of imaging sensors is configured to capture a second region of the scene such that the second region complements the first region, and (iii) a third imaging sensor of the plurality of imaging sensors is configured to capture a third region of the scene to ensure a comprehensive coverage for the map and an image processing.

In some aspects of the present disclosure, each imaging sensor of the plurality of imaging sensors are disposed at a distance (D) from an adjacent imaging sensor of the plurality of imaging sensors.

In some aspects of the present disclosure, the processing unit is configured to train the DNN model. Specifically, to train the DNN model, the processing unit is configured to crop an input image received from a dataset into a plurality of overlapping parts to generate a plurality of cropped images with a predefined pixel distance to replicate a multiple camera setup of the plurality of imaging sensors of the user device. The processing unit is configured to pass the plurality of cropped images to a plurality of encoders having a first set of trainable parameters such that the plurality of encoders generates a plurality of encoder outputs corresponding to the plurality of cropped images, add and pass the plurality of encoder outputs to a plurality of blocks where input and output is added having a second set of trainable parameters. The high dimensional spaces of the plurality of cropped images is aggregated to create a relationship between the plurality of cropped images. Generate a map of three-dimensional information by way of the decoder having a third set of trainable parameters. The generated map and a target map that is sampled from the dataset are compared to determine a loss value, wherein, based on the loss value, one or more weights of the plurality of encoders, the plurality of blocks where input and output is added, and the decoder are updated.

In some aspects of the present disclosure, each encoder of the plurality of encoders comprising a convolution layer with Batch Norm and ReLU, wherein each encoder of the plurality of encoders is configured to extract common overlapping portions to high dimensional space for the plurality of overlapping parts.

In some aspects of the present disclosure, the processing unit is configured to aggregate the high dimensional space of the three cropped images by adding the high dimensional spaces of the three cropped images extracted by the plurality of encoders.

In another aspect of the present disclosure, a method for generating a map of three-dimensional information is disclosed. The method includes steps of implementing, by way of a processing unit of a user device, a Deep Neural Network (DNN) model. Further, the method includes a step of capturing, by way of a plurality of imaging sensors, a plurality of images. Furthermore, the method includes a step of encoding and aggregating, by using a plurality of encoders and blocks where input and output is added of the DNN model implemented by way of the processing unit, respectively, information associated with the plurality of images in latent space. Furthermore, the method includes a step of generating, by using a decoder of the DNN model that is implemented by way of the processing unit, a map of three-dimensional information based on the encoded information corresponding to each image of the plurality of images such that the map illustrates distances between one or more objects in the scene and the plurality of imaging sensors.

### BRIEF DESCRIPTION OF DRAWINGS

The drawing/s mentioned herein disclose exemplary aspects of the present disclosure. Other objects, features, and advantages of the present disclosure will be apparent from the following description when read with reference to the accompanying drawing.

FIG. 1 illustrates a block diagram of a system to generate a map of three-dimensional information from a plurality of images captured by way of a plurality of imaging sensors, in accordance with an aspect of the present disclosure;

FIG. 2 illustrates a lock diagram of a processing unit of a user device of the system of FIG. 1; and

FIG. 3 is a flowchart that illustrates a method for generating a map of three-dimensional information from a plurality of images captured by way of a plurality of imaging sensors, in accordance with an aspect of the present disclosure.

To facilitate understanding, like reference numerals have been used, where possible to designate like elements common to the figures.

### DETAILED DESCRIPTION OF PREFERRED ASPECTS

Various aspect of the present disclosure provides a system and a method for capturing different scene regions and creating a real-time map for various applications, including parallax and bokeh effects. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element is referred to as being “on,” “connected to,” or “coupled to” another element, it can be directly on, connected to, or coupled to the other element or intervening elements that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this patent. Rather, the inventor/inventors have contemplated that the presented subject matter might also be embodied in other ways, to include different features or combinations of features similar to the ones described in this document, in conjunction with other technologies. As mentioned, there remains a need for a technical solution for capturing different scene regions and creating a real-time map of three-dimensional information for various applications, including parallax and bokeh effects. Generally, the various aspects including the example aspects relate to the system and the method for capturing different scene regions and creating a real-time map of three-dimensional information for various applications, including parallax and bokeh effects.

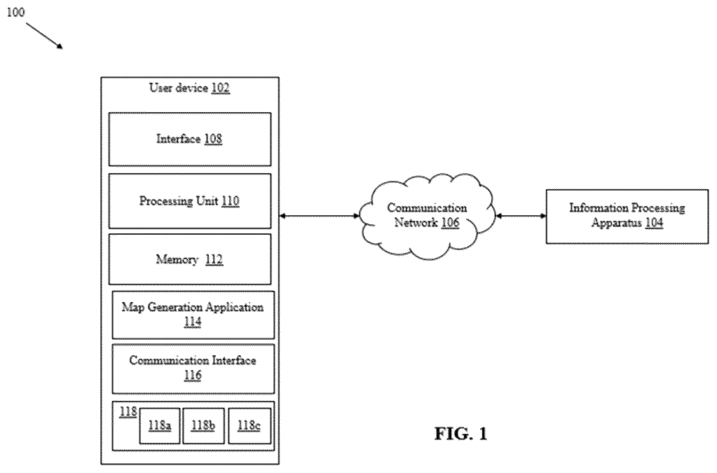

FIG. 1 illustrates a block diagram of a system 100 to generate real time maps of three-dimensional information from a plurality of images captured by way of a plurality of imaging sensors, in accordance with an aspect of the present disclosure. The system 100 may be configured to harness the power of deep learning and a Deep Neural Networks (DNNs) to better understand three-dimensional (3D) scenes such that the system 100 can be implemented in various applications such as, but not limited to, augmented reality, robotics, autonomous driving, and the like. The system 100 may be adapted to utilize multi-camera hardware configurations in mobile photography to enhance the overall quality and capabilities of mobile photography. The system 100 may be configured to generate a map of three-dimensional information such that the generated map serves as a foundational element for creating various parallax effects, encompassing circular parallax, left-right parallax, and further facilitating the generation of bokeh effects.

In some aspects of the present disclosure, the system 100 may be configured to generate maps of three-dimensional information from a plurality of images captured by way of a plurality of imaging sensors arranged in a substantially horizontal orientation. In some other aspects of the present disclosure, the system 100 may be configured to generate maps from a plurality of images captured by way of a plurality of imaging sensors arranged in a substantially vertical orientation. Specifically, the system 100 may be configured to generate maps of three-dimensional information using a plurality of images captured by a mobile device, optimized for efficient performance on mobile hardware.

The system 100 may include a user device 102 and an information processing apparatus 104. The user device 102 and the information processing apparatus 104 may be coupled to each other by way of a communication network 106 and/or through separate communication networks established there between.

The communication network 106 may include suitable logic, circuitry, and interfaces that may be configured to provide a plurality of network ports and a plurality of communication channels for transmission and reception of data related to operations of various entities in the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the information processing apparatus 104. The communication data may be transmitted and/or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In sone aspects of the present disclosure, the communication data may be transmitted or received via at least one communication channel of a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Metropolitan Area Network (MAN), a Satellite Network, the Internet, a Fiber Optic Network, a Coaxial Cable Network, an Infrared (IR) network, a Radio Frequency (RF) network, and a combination thereof. Aspects of the present disclosure are intended to include or otherwise cover any type of communication channel, including known, related art, and/or later developed technologies.

The user device 102 may be adapted to facilitate a user to input data, receive data, and/or transmit data within the system 100. In some aspects of the present disclosure, the user device 102 may be, but is not limited to, a desktop, a notebook, a laptop, a handheld computer, a touch sensitive device, a computing device, a smart phone, a smart watch, and the like. It will be apparent to a person of ordinary skill in the art that the user device 102 may be any device/apparatus that is capable of manipulation by the user. Although FIG. 1 illustrates that the system 100 includes a single user device (i.e., the user device 102), it will be apparent to a person skilled in the art that the scope of the present disclosure is not limited to it. In various other aspects, the system 100 may include multiple user devices without deviating from the scope of the present disclosure. In such a scenario, each user device is configured to perform one or more operations in a manner similar to the operations of the user device 102 as described herein.

The user device 102 may have an interface 108, a processing unit 110, and a memory 112. The interface 108 may have an input interface for receiving inputs from the user. Examples of the input interface may be, but are not limited to, a touch interface, a mouse, a keyboard, a motion recognition unit, a gesture recognition unit, a voice recognition unit, or the like. Aspects of the present disclosure are intended to include or otherwise cover any type of the input interface including known, related art, and/or later developed technologies. The interface 108 may further have an output interface for displaying (or presenting) an output to the user. Examples of the output interface may be, but are not limited to, a display device, a printer, a projection device, and/or a speaker, and the like.

The processing unit 110 may be configured to execute various operations, such as one or more operations associated with the user device 102. In some aspects of the present disclosure, the processing unit 110 may be configured to control one or more operations executed by the user device 102 in response to an input received at the user device 102 from a user. Specifically, the processing unit 110 may be configured to generate a map of three-dimensional information based on a plurality of images of a scene captured by way of a plurality of imaging sensors 118 such that the generated map serves as a foundational element for creating various parallax effects, encompassing circular parallax, left-right parallax, and further facilitating the generation of bokeh effects. Examples of the processing unit 110 may be, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Programmable Logic Control unit (PLC), and the like. Aspects of the present disclosure are intended to include or otherwise cover any type of the processing unit 110 including known, related art, and/or later developed technologies. In some aspects of the present disclosure, the map network of the present disclosure may be deployed on the processing unit 110 using FP16 or INT8 quantization.

The memory 112 may be configured to store logic, instructions, circuitry, interfaces, and/or codes of the processing unit 110, data associated with the user device 102, and data associated with the system 100. Examples of the memory 112 may include, but are not limited to, a Read Only Memory (ROM), a Random Access Memory (RAM), a Flash Memory (FM), a Removable Storage Drive (RSD), a Hard Disk Drive (HDD), a Solid-State Memory (SSM), a Magnetic Storage Drive (MSD), a Programmable Read Only Memory (PROM), an Erasable PROM (EPROM), and/or an Electrically EPROM (EEPROM). Aspects of the present disclosure are intended to include or otherwise cover any type of the memory 112 including known, related art, and/or later developed technologies.

In some aspects of the present disclosure, the user device 102 may further have one or more computer executable applications configured to be executed by the processing unit 110. The one or more computer executable applications may have suitable logic, instructions, and/or codes for executing various operations associated with the system 100. The one or more computer executable applications may be stored in the memory 112. Examples of the one or more computer executable applications may include, but are not limited to, an audio application, a video application, a social media application, a navigation application, and the like. Preferably, the one or more computer executable applications may include a map generation application 114. In some aspects of the present disclosure, one or more operations associated with the map generation application 114 may be controlled by the processing unit 110. In some other aspects of the present disclosure, the map generation application 114 may be controlled by the information processing apparatus 104.

The user device 102 may further have a communication interface 116. The communication interface 116 may be configured to enable the user device 102 to communicate with the information processing apparatus 104 and other components of the system 100 over the communication network 106. Examples of the communication interface 116 may be, but are not limited to, a modem, a network interface such as an Ethernet Card, a communication port, and/or a Personal Computer Memory Card International Association (PCMCIA) slot and card, an antenna, a Radio Frequency (RF) transceiver, one or more amplifiers, a tuner, one or more oscillators, a digital signal processor, a Coder Decoder (CODEC) Chipset, a Subscriber Identity Module (SIM) card, and a local buffer circuit. It will be apparent to a person of ordinary skill in the art that the communication interface 116 may have any device and/or apparatus capable of providing wireless and/or wired communications between the user device 102 and the information processing apparatus 104.

The user device 102 may further include a plurality of imaging sensors 118 of which first through third imaging sensors 118a-118c are shown. In some aspects of the present disclosure, the first through third imaging sensors 118a-118c may be disposed in a substantially horizontal orientation. In some aspects of the present disclosure, the first through third imaging sensors 118a-118c may be disposed in a substantially horizontal orientation. In some aspects of the present disclosure, the first through third imaging sensors 118a-118c may be disposed in a substantially horizontal orientation. In some other aspects of the present disclosure, the first through third imaging sensors 118a-118c may be disposed in a substantially vertical orientation. In some aspects of the present disclosure, the first through third imaging sensors 118a-118c may be disposed in any orientation such that the first through third imaging sensors 118a-118c facilitates in generation (generation in all directions/axes) of various effects such as, but not limited to, a parallax effect, a bokeh effect, and the like, without deviating from the scope of the present disclosure. In some aspects of the present disclosure, each imaging sensor of the first through third imaging sensors 118a-118c may be disposed at a predefined distance (D) from an adjacent imaging sensor of the first through third imaging sensors 118a-118c. For example, the first imaging sensor 118a may be disposed at the predefined distance (D) from the second imaging sensor 118b, the second imaging sensor 118b may be disposed at the predefined distance (D) from the third imaging sensor 118c. Although FIG. 1 illustrates that the plurality of imaging sensors 118 includes three imaging sensors (i.e., the first through third imaging sensors 118a-118c), it will be apparent to a person skilled in the art that the scope of the present disclosure is not limited to it. In various other aspects, the plurality of imaging sensors 118 may include any number of imaging sensors that may facilitate in generation of various effects such as, but not limited to, a parallax effect, a bokeh effect, and the like, without deviating from the scope of the present disclosure. In some aspects of the present disclosure, the first imaging sensor 118a may be configured to capture a first region of a scene such that the first designated region contributes to the map of three-dimensional information and an image composition. The second imaging sensor 118b may be configured to capture a second region of the scene such that the second region complements the first region. The third imaging sensor 118c may be configured to capture a third region of the scene to ensure a comprehensive coverage for the map and an image processing.

The information processing apparatus 104 may be a network of computers, a framework, and/or a combination thereof, that may provide a generalized approach to create a server implementation. In some aspects of the present disclosure, the information processing apparatus 104 may be a server. Examples of the information processing apparatus 104 may be, but are not limited to, personal computers, laptops, mini-computers, mainframe computers, any non-transient and tangible machine that can execute a machine-readable code, cloud-based servers, distributed server networks, or a network of computer systems. The information processing apparatus 104 may be realized through various web-based technologies such as, but not limited to, a Java web-framework, a .NET framework, or any other web-application framework. The information processing apparatus 104 may have one or more processing circuitries (not shown) and a non-transitory computer-readable storage medium (not shown).

In operation, the processing unit 110 of the user device 102 may be configured to create a dataset. Specifically, to create the dataset, the processing unit 110 may sample a single input image from the dataset. Further, the processing unit 110 may be configured to crop the single input image into three overlapping parts (hereinafter interchangeably referred to as “the three cropped images”) with a predefined pixel distance. Furthermore, the processing unit 110 may be configured to implement and execute one or more mathematical filters to the three cropped images for color-based overfitting. Specifically, the processing unit 110 may be configured to implement and execute a DNN network having an encoder/decoder architecture such that each cropped image of the three cropped images is passed to an encoder (i.e., for three cropped images, three encoders are used), which consists of four blocks containing a convolution layer with Batch Norm and ReLU to extract common overlapping portions to high dimensional space for three overlapping crops.

The processing unit 110 may be further configured for high dimensional space aggregation. Specifically, for the high dimensional space aggregation, the processing unit 110 may be configured to aggregate a high dimensional space of the three cropped images by adding the high dimensional spaces of the three cropped images extracted by the three encoders. Specifically, the high dimensional space aggregation may facilitate in creating a better relationship between the three cropped images. The processing unit 110 may be configured to aggregate the high dimensional space of the three cropped images by using self-attention to establish a relationship between the three cropped images. In some aspects of the present disclosure, to better aggregate the added information from the three cropped images, the processing unit 110 may be configured to pass the high dimensional aggregated space to the convolution block with Batch Norm and ReLU. Furthermore, the input of the convolution block may be added to an output for better high dimensional flow. Further, the output may be passed through decoder blocks, which consist of Transpose Convolution Blocks with BatchNorm and ReLU. Specifically, four decoder blocks and the last Convolution Block may have only a single channel as output.

Further, the processing unit 110 may be configured to sample a target map from the dataset. Furthermore, the processing unit 110 may be configured to determine loss using Feature Matching Loss and VGG loss with a network trained on Imagenet for classification as a loss function. Additionally, the processing unit 110 may be configured to use seven Discriminator Networks for GAN based loss determination.

It will be apparent to a person skilled in the art that the dataset creation and the aggregation of the high dimensional space are shown to be executed by way of the processing unit 110 of the user device 102 to make the illustrations concise and clear and should not be considered as a limitation of the present disclosure. In various other aspects of the present disclosure, the dataset creation and the aggregation of the high dimensional space can be executed by way of the information processing apparatus 104, without deviating from the scope of the present disclosure. The processing unit 110 may be further configured to implement a pipeline using encoder-decoder architecture to feed multiple images of a particular scene taken by different cameras located at different positions. The encoder-decoder may be trained by replicating the multi-camera setup in the training dataset.

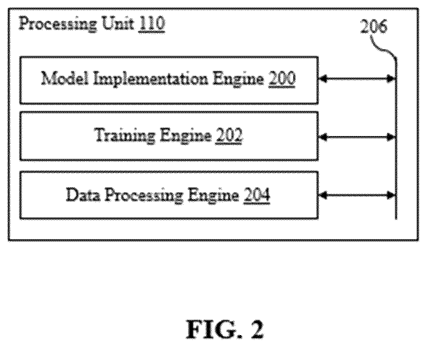

FIG. 2 is a block diagram that illustrates the processing unit 110 of the user device 102 of FIG. 1, in accordance with an aspect of the present disclosure. As discussed, the processing unit 110 may be coupled to the memory 112. Further, the processing unit 110 may include a model implementation engine 200, a training engine 202, and a data processing engine 204. The model implementation engine 200, the training engine 202, and the data processing engine 204 may communicate with each other by way of a communication bus 206. It will be apparent to a person having ordinary skill in the art that the information processing apparatus 104 is for illustrative purposes and not limited to any specific combination of hardware circuitry and/or software.

The processing circuitry 120 may be configured to perform one or more operations associated with the system 100 by way of the model implementation engine 200, the training engine 202, and the data processing engine 204. The model implementation engine 200 may include suitable logic, circuitry, interfaces, and/or codes to perform one or more operations. For example, the model implementation engine 200 may be configured to implement a Deep Neural Network (DNN) model that may be trained by way of the training engine 202 to generate a real time map of three-dimensional information based on a plurality of images of a scene captured by way of the plurality of imaging sensors 118. The training engine 202 may include suitable logic, circuitry, interfaces, and/or codes to perform one or more operations. For example, the training engine 202 may be configured to train the DNN model based on sample images that may be sampled from a training dataset such as, but not limited to, ImageNet dataset, and the like. Aspects of the present disclosure are intended to include and/or otherwise cover any type of the training dataset, known to a person having ordinary skill in the art, without deviating from the scope of the present disclosure. The training engine 202 may be configured to sample an input image and corresponding map associated with the input image from the dataset. Further, the training engine 202 may be configured to crop the input image received from the dataset into a plurality of overlapping parts with a predefined pixel distance such that the plurality of overlapping parts replicate a multiple camera setup such as the plurality of imaging sensors 118 of the user device 102. Specifically, the plurality of overlapping parts between the cropped images may overlap that may replicate a setup of the plurality of imaging sensors 118 of the user device 102 for training. The cropped images may be passed through the encoder of the DNN model, which has trainable parameters. In other words, the plurality of overlapping parts of the cropped images may be passed to a plurality of encoders having a first set of trainable parameters. In some aspects of the present disclosure, as the cropped images are three images having the plurality of overlapping parts, the plurality of encoders may include three encoders. The plurality of encoders may be configured to generate a plurality of encoder outputs corresponding to the plurality of cropped images. In some aspects of the present disclosure, the training engine 202 may be configured to add the plurality of encoder outputs. The training engine 202 may be further configured to pass the plurality of encoder outputs to blocks where input and output is added of the DNN model having a second set of trainable parameters Specifically, the plurality of encoder outputs i.e., a high dimensional space of the three cropped images may be aggregated by simply adding the high dimensional spaces of the three cropped images extracted by the plurality of encoders to create a better relationship between the plurality of cropped images. In some aspects of the present disclosure, the high dimensional space of the plurality of cropped images may be aggregated by using self-attention to establish a relationship between the plurality of cropped images. Specifically, to aggregate the added information from the plurality of cropped images, the training 202 may be configured to pass the high dimensional aggregated space to the Convolution Block with Batch Norm and ReLU such that the inputs of convolution block are added to an output for better high dimensional flow. The training engine 202 may be further configured to enable the decoder of the DNN model to generate a map of three-dimensional information. The decoder of the DNN model may have a third set of trainable parameters. In some aspects of the present disclosure, the decoder of the DNN model may include Transpose Convolution Blocks with BatchNorm and ReLU. The training engine 202 may be configured to utilize four such blocks such that the last Convolution Block includes only a single channel as output i.e., the map of three-dimensional information. Further, the training engine 202 may be configured to compare the generated map and the sampled map from the dataset to determine a loss value. Further, the training engine 202 may be configured to update one or more weights associated with the plurality of encoders of the DNN model, the blocks where input and output is added of the DNN model, and the decoder of the DNN model to fine tune the DNN model. In some aspects of the present disclosure, the training engine 202 may be configured to utilize a Learned Perceptual Image Patch Similarity (LPIPS) Loss function, a Mean Square Error (MSE) Loss function, and an Adversarial Loss functions to train the DNN model.

Once the training dataset is created and the model is trained using the training dataset, the user device 102 may be utilized by a user to capture the set of images by way of the plurality of imaging sensors 118 of the user device 102. In other words, the plurality of imaging sensors 118 (i.e., the first through third imaging sensors 118a-118c) may be utilized to capture the set of images (i.e., first through third images, respectively) of a particular scene at same time from slightly different viewpoints. The plurality of imaging sensors 118 may be configured to provide the set of images to the processing unit 110 of the user device 102. The processing unit 110 may be configured to process the plurality of images by way of one or more Artificial intelligence techniques and/or machine learning techniques to generate a single channel image i.e., a map of three-dimensional information that may be further utilized to generate various effects such as, but not limited to, a parallax effect, a bokeh effect, and the like.

The data processing engine 204 may be configured to pass the set of images to the implemented and trained DNN model. Specifically, the data processing engine 204 by way of the trained DNN model may process the set of images and generate an output as a single channel image, which is a map of three-dimensional information. The DNN model may have a plurality of encoders (i.e., neural networks) for an encoding phase. Specifically, for the three images (i.e., the first through third images), the DNN model may have three encoders (i.e., the first through third encoders). The first through third encoders may employ deep convolutional layers to analyze and encode spatial information from the first through third images, respectively. Specifically, the first through third encoders may be configured to detect one or more features from the first through third images, respectively. The one or more features may include, but is not limited to, edges, textures, object boundaries, and the like. Further, the first through third encoders may be configured to represent the detected one or more features from the first through third images, respectively, in a compact and abstract form. In some aspects of the present disclosure, the first through third encoders may be configured to receive the first through third images, respectively in RGB color format. Each encoder of the first through third encoders may include a Deep Neural Network (DNN), followed by a batch normalization function and a Rectified Linear Unit (ReLU) activation function. Specifically, each encoder of the first through third encoders may have three layers i.e., a DNN layer, a BatchNorm layer (i.e., batch normalization function), and ReLU layer (i.e., the ReLU function). The first through third encoders may be configured to extract the information (i.e., the first through third images) from the first through third imaging sensors 118a-118c, respectively, and mix the information from the first through third imaging sensors 118a-118c in a latent space of the first through third encoders, respectively. Due to the addition of the information in the latent space, the information from all the first through third imaging sensors 118a-118c is fused. The data processing engine 204 may be further configured to add the information to generate a summed version of the information. Further, the data processing engine 204 may be configured to enable the blocks where input and output is added to process the summed version of the information. Specifically, the summed version of the information from the first through third imaging sensors 118a-118c may be interpreted in the blocks where input and output is added of the DNN model.

The data processing engine 204 may be further configured to enable the decoder of the DNN model to convert the encoded information (i.e., the summed version of the information) into a map of three-dimensional information such that the map illustrates distances between one or more objects in the first through third images and the plurality of imaging sensors 118. Specifically, the decoder may be configured to reconstruct the map by transforming the encoded features into depth values. The decoder may specifically utilize a combination of transpose convolution with batch normalization and the ReLU activation function. The transpose convolution operation upscales the feature map. Specifically, three layers of transpose convolution may be utilized, batch normalization, and ReLU for the decoder. In some aspects of the present disclosure, the distance between the plurality of imaging sensors 118a-118c of the user device 102 may be combined and passed to a block where input and output is added of the DNN model. Further, the output of the blocks where input and output is added may be passed to the decoder. The decoder may be specifically configured to capture one or more features of the plurality of imaging sensors 118a-118c and generate a single map from all the plurality of imaging sensors 118. Specifically, the output of the decoder may be a single-channel image in grayscale. In some aspects of the present disclosure, the encoding and decoding process may involve up-sampling and refining the feature maps to produce a high-resolution map.

The generated map may provide pixel-level depth information for each point in the scene, allowing the processing unit 110 for precise spatial understanding. Specifically, the generated map represents the scene's three-dimensional structure, with closer objects having brighter pixels and farther objects appearing darker.

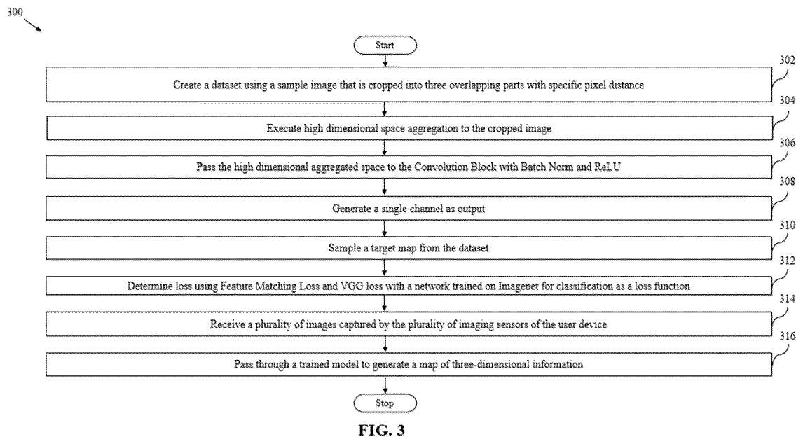

FIG. 3 is a flowchart that illustrates a method 300 for generating maps of three-dimensional information from a plurality of images captured by way of a plurality of imaging sensors 118 of the user device 102, in accordance with an aspect of the present disclosure.

At step 302, the processing unit 110 of the user device 102 may create a dataset for training a DNN model. The dataset may be created using a sample image that is cropped into three overlapping parts with specific pixel distance.

At step 304, the processing unit 110 of the user device 102 may be configured to execute high dimensional space aggregation to the cropped image.

At step 306, the processing unit 110 of the user device 102 may pass the high dimensional aggregated space to the Convolution Block with Batch Norm and ReLU. Furthermore, the processing unit 110 adds the input of convolution block to output for better high dimensional flow.

At step 308, the processing unit 110 of the user device 102 generates a single channel as output by utilizing decoder blocks, that have Transpose Convolution Blocks with BatchNorm and ReLU. Specifically, four decoder blocks are utilized.

At step 310, the processing unit 110 of the user device 102 may sample the target map from the dataset.

At step 312, the processing unit 110 of the user device 102 may determine loss using Feature Matching Loss and VGG loss with a network trained on ImageNet or MS COCO for classification as a loss function. Additionally, the processing unit 110 utilizes seven Discriminator Network for GAN based loss calculations.

At step 314, the processing unit 110 of the user device 102 may receive a plurality of images captured by the plurality of imaging sensors 118 of the user device 102 such that each imaging sensor of the plurality of imaging sensors 118 is disposed at a predefined distance (D) from an adjacent imaging sensor of the plurality of imaging sensors 118.

At step 316, the plurality of images may be passed through the trained model to generate a map of three-dimensional information.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each aspect. Rather, as the following aspects reflect, inventive aspects lie in less than all features of a single foregoing disclosed aspect, configuration, or aspect. Thus, the following aspects are hereby incorporated into this Detailed Description, with each aspect standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those disclosed, whether or not such alternate, interchangeable and/or equivalent structures, functions, ranges or steps are disclosed herein, and without intending to publicly dedicate any patentable subject matter.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential.

Certain terms are used throughout the following description and aspects to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure.

We claim:

1. A user device (102) comprising:
a plurality of imaging sensors (118) configured to capture a plurality of images of a scene; and
a processing unit (110) that is coupled to the plurality of imaging sensors (118), and configured to implement a Deep Neural Network (DNN) model, wherein the DNN model is configured to:
encode and aggregate, by way of a plurality of encoders and blocks where input and output is added, respectively, information associated with the plurality of images in latent space; and
generate, by way of a decoder, a map of three-dimensional information based on the encoded information corresponding to each image of the plurality of images such that the map illustrates distances between one or more objects in the scene and the plurality of imaging sensors (118).

2. The user device (102) of claim 1, wherein the plurality of imaging sensors (118) comprising first through third imaging sensors (118a-118c) such that (i) the first imaging sensor (118a) is configured to capture a first region of a scene such that the first designated region contributes to the map and an image composition, (ii) the second imaging sensor (118b) is configured to capture a second region of the scene such that the second region complements the first region, and (iii) the third imaging sensor (118c) is configured to capture a third region of the scene to ensure a comprehensive coverage for the map and an image processing.

3. The user device (102) of claim 1, wherein each imaging sensor of the plurality of imaging sensors (118) are disposed at a predefined distance (D) from an adjacent imaging sensor of the plurality of imaging sensors (118).

4. The user device (102) of claim 1, wherein the processing unit (110) is configured to train the DNN model, wherein to train the DNN model, the processing unit (110) is configured to:
crop an input image received from a dataset into a plurality of overlapping parts to generate a plurality of cropped images with a predefined pixel distance to replicate a multiple camera setup of the plurality of imaging sensors (118) of the user device (102);
generate a plurality of encoder outputs by way of a plurality of encoders of the DNN model that corresponds to the plurality of cropped images, wherein the plurality of encoders has a first set of trainable parameters;
aggregate high dimensional spaces of the plurality of cropped images by way of blocks where input and output is added to create a relationship between the plurality of cropped images, wherein the blocks where input and output is added have second set of trainable parameters; and
generate a map of three-dimensional information by way of the decoder having a third set of trainable parameters, wherein the generated map and a target map that is sampled from the dataset are compared to determine a loss value, wherein, based on the loss value, one or more weights of the plurality of encoders, the plurality of blocks where input and output is added, and the decoder are updated.

5. The user device (102) of claim 1, wherein each encoder of the plurality of encoders comprising a convolution layer with Batch Norm and ReLU, wherein each encoder of the plurality of encoders is configured to extract common overlapping portions to high dimensional space for the plurality of overlapping parts.

6. A method (300) for generating a map of three-dimensional information, wherein the method (300) comprising:
implementing, by way of a processing unit (110) of a user device (102), a Deep Neural Network (DNN) model;
capturing, by way of a plurality of imaging sensors (118), a plurality of images;
encoding and aggregating, by using a plurality of encoders and blocks where input and output is added of the DNN model implemented by way of the processing unit (110), respectively the processing unit (110), information associated with the plurality of images in latent space; and
generating, by using a decoder of the DNN model that is implemented by way of the processing unit (110), a map of three-dimensional information based on the encoded information corresponding to each image of the plurality of images such that the map illustrates distances between one or more objects in the scene and the plurality of imaging sensors (118).

7. The method (200) of claim 9, wherein for training the DNN model, the method (300) comprising:
cropping, by way of the processing unit (110), an input image received from a dataset into a plurality of overlapping parts to generate a plurality of cropped images with a predefined pixel distance to replicate a multiple camera setup of the plurality of imaging sensors (118) of the user device (102);
passing the plurality of cropped images to a plurality of encoders of the DNN model such that the plurality of encoders generates a plurality of encoder outputs corresponding to the plurality of cropped images, wherein the plurality of encoders has a first set of trainable parameters;
adding and passing the plurality of encoder outputs to blocks where input and output is added of the DNN model, wherein high dimensional spaces of the plurality of cropped images is aggregated to create a relationship between the plurality of cropped images, wherein the blocks where input and output is added have a second set of trainable parameters; and
generate a map of three-dimensional information by way of the decoder of the DNN model, wherein the decoder has a third set of trainable parameters, wherein the generated map and a target map that is sampled from the dataset are compared to determine a loss value, wherein, based on the loss value, one or more weights of the plurality of encoders, the plurality of blocks where input and output is added, and the decoder are updated.

8. The method (300) of claim 6, wherein the plurality of imaging sensors (118) comprising first through third imaging sensors (118a-118c) such that (i) the first imaging sensor (118a) is configured to capture a first region of a scene such that the first designated region contributes to the map and an image composition, (ii) the second imaging sensor (118b) is configured to capture a second region of the scene such that the second region complements the first region, and (iii) the third imaging sensor (118c) is configured to capture a third region of the scene to ensure a comprehensive coverage for the map and an image processing.

9. The method (300) of claim 6, wherein each imaging sensor of the plurality of imaging sensors (118) are disposed at a predefined distance (D) from an adjacent imaging sensor of the plurality of imaging sensors (118).

10. The method (300) of claim 6, wherein each encoder of the plurality of encoders comprising a convolution layer with Batch Norm and ReLU, wherein each encoder of the plurality of encoders is configured to extract common overlapping portions to high dimensional space for the plurality of overlapping parts.
